(19) United States
(12) Patent Application Publication
(10) Pub. No.: US 2003/0101117 A1
(43) Pub. Date: May 29, 2003

(54) Generating contract requirements for software suppliers based upon assessing the quality levels of quality attributes of the suppliers

(75) Inventors: Timothy Alan Dietz, Austin, TX (US); Xiaoyu Shi, Austin, TX (US); Drew A. Terry, Round Rock, TX (US); Charles Gorham Ward, Austin, TX (US); Frank Albert Zammarchi JR., Boca Raton, FL (US)

Correspondence Address: Mark E. McBurney, International Business Machines Corporation, Intellectual Property Law Dept., Internal Zip 4054, 11400 Burnet Road, Austin, TX, 11400, US

(73) Assignee: International Business Machines Coproation, Armonk, NY

(21) Appl. No.: 09/998,046

(22) Filed: Nov. 29, 2001

(51) Int. Cl. G06F 17/60

(52) U.S. Cl. 705/35; 705/37

(57) ABSTRACT

A computer controlled display system for automatically generating quality assurance contract requirements. The quality level of each of a set of quality attributes of a software supplier is assessed, and at least one contract requirement for each of said quality attributes for said supplier is generated based upon the quality level of said attribute. The assessment of the quality level preferably involves determining one of a plurality of quality levels for each of said set of quality attributes, and generating a different contract requirement for each of said quality levels for each attribute. The set of quality attributes may consist of a single overall quality characteristic having several predetermined quality levels. In such a case, there is generated a plurality of contract requirements for each of said predetermined quality levels.

### TECHNICAL FIELD

The present invention relates to a method and system of doing business using an interactive computer controlled display system and method as an aid in generating contracts with suppliers.

### BACKGROUND OF RELATED ART

Over the past decade, businesses have been undergoing major changes in the ways that they conduct their business. One of the most dramatic trends has been in the reduction of employees, functions and facilities through the out-sourcing of virtually anything that can be out-sourced. This has made many businesses leaner and more competitive with significantly reduced staffs and facilities to be maintained. However, along with these advantages has come a loss in control of the performance of many functions, as well as a diminished ability to control the quality of the resulting products.

Nowhere has this diminished control on the part of the business developer of products or systems become more pronounced than in the supplying of software from outside suppliers. Over its first forty years prior to the 1980's, the software development environment was one in which an individual or a small dedicated group willing to put in long hard hours could create “elegant” software or “killer applications” directed to and effective in one or more of the limited computer system environments existing at the time.

Unlike hardware or industrial product development, the development of software did not require substantial investment in capital equipment and resources. Consequently, in the software product field, the business and consumer marketplace to which the software is directed has traditionally expected short development cycles from the time that a computer need and demand became apparent to the time that a commercial software product fulfilling the need became available.

Unfortunately, with the explosion of computer usage and the resulting wide diversity of computer systems that must be supported by, or at least not incompatible with, each newly developed computer software product, the development cycles have become very complex. Even when the software product development is an upgrade of an existing product, every addition, subtraction or modification of the program could have an insignificant or a profound effect on another operating system or application program that must be supported.

During the evolution of the software industries over the past two decades it has been evident that developing software will be combined in new, often unforeseen, ways, and, thus, there is an increased likelihood that the individual developments will drive system programs that must be supported into inoperable states for certain purposes or under certain conditions. This changed development environment has caused many traditional and responsible software development houses to take the time and make the effort to resolve all potential incompatibilities with all existing and standard software before the new developed software products were commercially released. Unfortunately, the computer industry landscape is littered with the “corpses” of such responsible longer development cycle software houses that lost out to newer software product entrepreneurs that rushed to the market, or to buyers with products that were less than complete.

Whether the customer of a software supplier is acquiring the software for specific internal needs or to be incorporated into broader products to be marketed by the customer, dysfunctional software products from even one supplier can derail an entire enterprise with profound marketing or economic effects. Accordingly, processes and systems do exist for assessing the quality levels of software suppliers. Copending U.S. patent application Ser. No. 09/710,920, Timothy A. Dietz et al., Business Method for Performing Qualifications of Software and Software Development organizations, filed Nov. 9, 2000, and assigned to the same assignee of the present invention, provides an effective method for accessing the quality of software suppliers.

Unfortunately, because of the extensive need for software suppliers due to extensive business out-sourcing, together with the high turnover in reliable software suppliers, it may often be difficult for system developers to get software suppliers of known reliability to provide for their software requirements on the developer's schedules. Consequently, it may often be the case that the software supplier may be less than the best available supplier or may be of relative unknown quality.

It is not enough that the software supplier provide the customer with financial guarantees as to quality and schedules. The suppliers often will not have the resources to make up for the substantial losses which may result from defective software.

In addition, in the present business environment where a business may routinely rely on great numbers of purchase contracts with a variety of suppliers, there is a need to provide production management with a process that aids them in generating satisfactory contracts for software suppliers quickly without the delay of routinely having to consult with higher management or legal staff.

### SUMMARY OF THE PRESENT INVENTION

The present invention provides a computer controlled display system for automatically generating quality assurance contract requirements. The invention involves the combination of assessing the quality level of each of a set of quality attributes of a software supplier, and generating for each of said quality attributes at least one contract requirement for the supplier based upon the quality level of said attribute. The assessment of the quality level preferably involves determining one of a plurality of quality levels for each of said set of quality attributes, and generating a different contract requirement for each of said quality levels for each attribute. It may be the case that the contractor's potential for performance of more and more quality attributes may be so good that no contract requirement needs to be generated for at least one of said quality levels for at least one of said quality attributes. The invention further provides means for determining said quality levels which determines said levels dynamically during the system operation.

The set of quality attributes may consist of a single overall quality characteristic having several predetermined quality levels, and the means for generating provides a plurality of contract requirements for each of said predetermined quality levels.

Some examples of significant contract requirements are tracking and reporting of said software development; tracking and reporting of testing of said software; software supplier risk identification and reduction; and the management processes of said supplier.

The present invention may be used to provide the software supplier with automatic contract requirements as part of work flow distribution systems in which the software supply functions are assigned to said software suppliers as part of an overall work flow distribution system, and the means for generating automatically generate and distribute said contract requirements to said supplier in response to the selection of said supplier.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter that is capable of functioning as an interactive user's computer controlled display on which the display system of the present invention may be used to generate contract requirements responsive to assessments of quality attributes of software suppliers;

FIG. 2 is a diagrammatic view of a display screen on a computer terminal shown in FIG. 1 wherein the user has entered the name of a proposed supplier, and the system has provided the supplier's overall assessed quality level;

FIG. 3 is the diagrammatic view of FIG. 2 where the system has provided the contract requirements for the assessed software supplier of FIG. 2;

FIG. 4 is a diagrammatic view of a display screen on a computer terminal like that shown in FIG. 2 wherein the user has entered the name of a proposed supplier, and the system has provided the supplier's overall assessed quality levels in a plurality of attributes;

FIG. 5 is the diagrammatic view of FIG. 4 where the system has provided the contract requirements for the assessed software supplier of FIG. 4 as related to each of the plurality of assessed attributes;

FIG. 6 is an illustrative flowchart describing the setting up of the process of the present invention for the generation of quality assurance contract requirements; and

FIG. 7 is a flowchart of an illustrative run of the process setup in FIG. 6.

### DETAILED DESCRIPTION OF THE PREFERRED EMBODIMENT

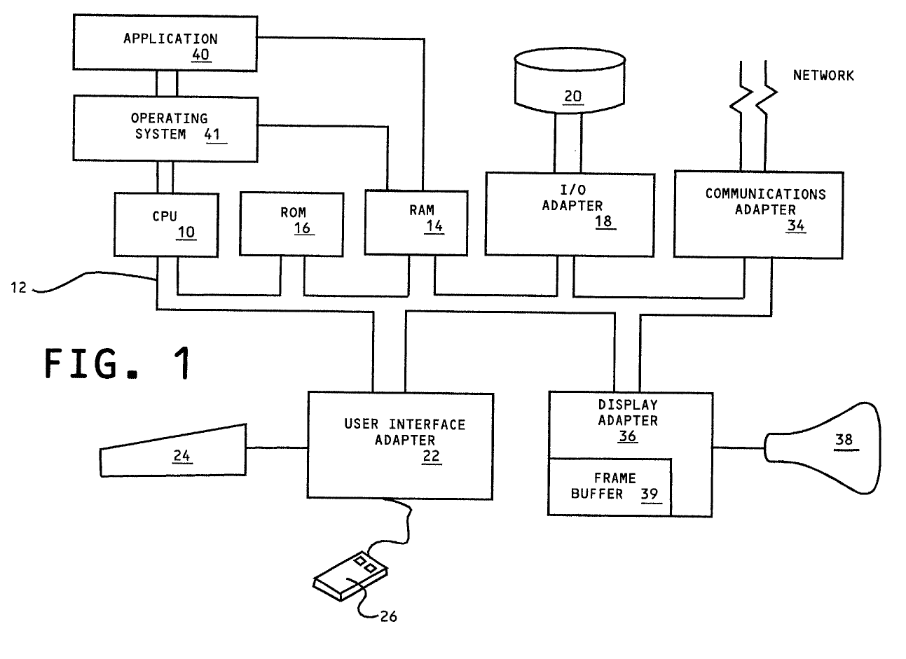

Referring to FIG. 1, a typical data processing terminal is shown that may function as the computer control terminals for generating quality control requirements for software suppliers in accordance with the present invention. A central processing unit (CPU) 10, such as one of the PC microprocessors or workstations, e.g. eServer pseries available from International Business Machines Corporation (IBM), or Dell PC microprocessors, is provided and interconnected to various other components by system bus 12. An operating system 41 runs on CPU 10, provides control and is used to coordinate the function of the various components of FIG. 1. Operating system 41 may be one of the commercially available operating systems such as IBM's AIX 6000™ operating system or Microsoft's WindowsMe™ or Windows 2000™, as well as UNIX and other IBM operating systems. Application programs 40, controlled by the system, are moved into and out of the main memory Random Access Memory (RAM) 14. These programs include the program of the present invention for generating quality control requirements for software suppliers which will hereinafter be described in greater detail. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside Internet or Web network. I/O devices are also connected to system bus 12 via user interface adapter 22 and display adapter 36. Keyboard 24 and mouse 26 are all interconnected to bus 12 through user interface adapter 22. It is through such input devices that the user may interactively relate to the programs for generating contract requirements.

Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

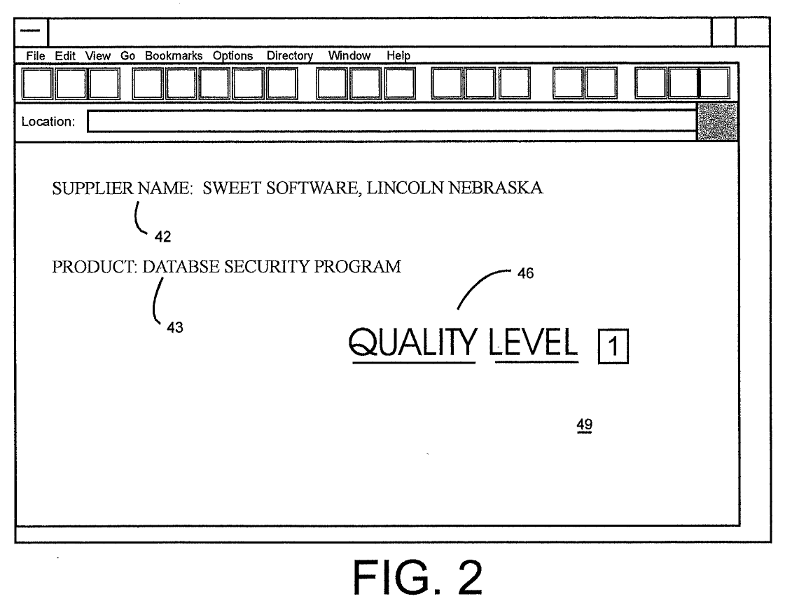

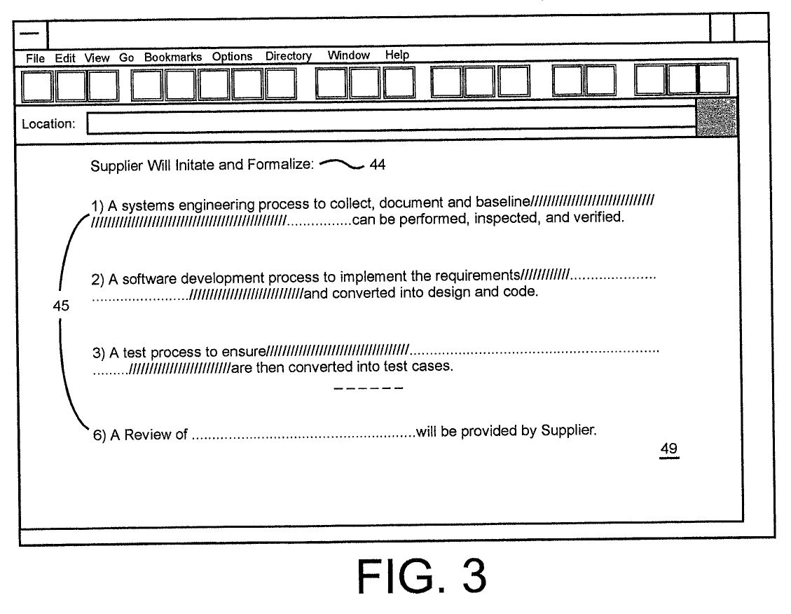

With reference to FIG. 2, an illustrative display screen for generating contract requirements for selected software suppliers is shown. This first illustration will be a general application of the invention wherein the proposed software supplier is given a single overall quality assessment. In this example, the user has entered the supplier's name 42, Sweet Software, and the type of software product to be delivered 43. The system has provided a quality level 46 of “1” on display screen 49. For purposes of the present illustration, the quality assessment rating levels are on a scale of 1 through 5 with 1 being the lowest quality rating and 5 being the highest rating. How the software supplier is being assessed, which involves the generation of the contract provisions in response to such assessments, is not a function of the present invention. The above-referenced U.S. patent application Ser. No. 09/710,920, offers a convenient process for assessment of software suppliers. New suppliers may be given a quality assessment level based upon interviews, visits to facilities and responses to data entry computer dialogues. Of course suppliers with whom the user has had business experience may be assessed upon such business experience. In any event, the illustration shown in FIG. 2 involved a single overall assessment level. Since it is relatively low, i.e. “1”, the system will generate several contract provisions 45 on the display screen 49 of FIG. 3, which the software supplier must initiate and formalize 44.

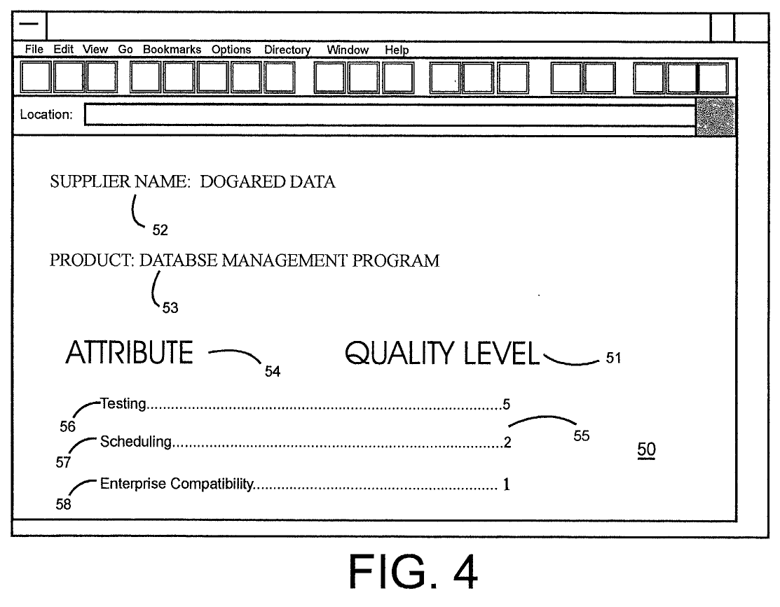

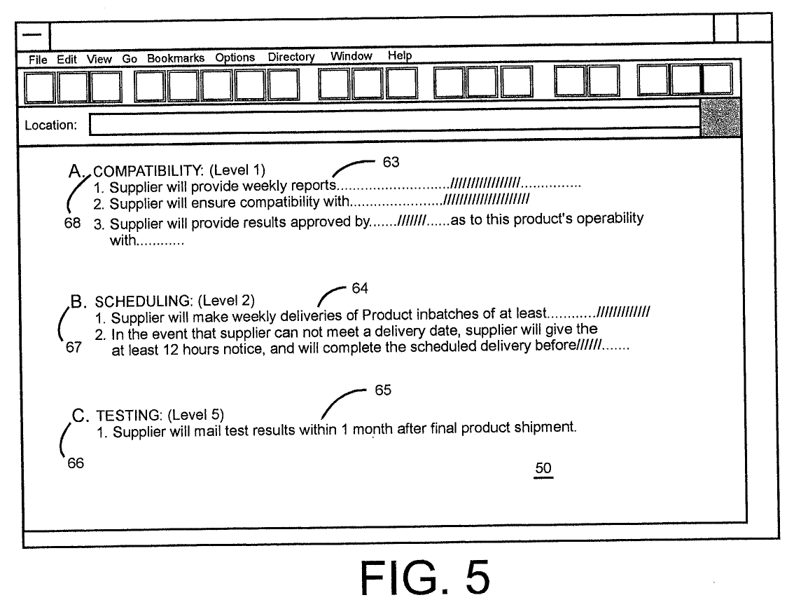

Instead of a single general assessment as shown in FIGS. 2 and 3, the supplier may be assessed for several quality attributes as illustrated in FIGS. 4 and 5. In FIG. 4, the user has entered the name “Dogeared Data” 52 on display screen 50, as a supplier of a database management software 53 product, and the system has generated quality levels 51 for a set of attributes 54. The levels 55 are, for example, for Testing 56, Scheduling 56 and Enterprise Compatibility 58 attributes. As a result, the system has, as illustrated in FIG. 5, generated respective sets of contract requirements 64, 65 and 63 relative to the Testing 66, Scheduling 67 and Compatibility 68.

The contract requirements may be predetermined and stored so that as a particular quality level for a particular attribute is determined, its corresponding predetermined set of contract provisions may be accessed from storage and displayed to be included in any contract with the supplier. It should be noted that the quality levels of suppliers may be continuously and automatically modified as the user's experience with the particular supplier develops.

The system and method of the present invention may be used as part of an overall work flow distribution system. These systems are collaborative computer controlled distributions of functions and work processes. For the present state of the work flow distribution art, reference may be made to the text, Production Workflow Concepts and Techniques, Frank Leymann et al., published 2000, Prentice Hall, New Jersey. Companies no longer have to use phone calls or mail orders to do business with each other. Through the use of networks such as the Internet, business processes of different companies handle each others' requests without any manual intervention; no interaction is required to have one business process talk to another business process of a different company. In such work flow distribution systems, the system of the present invention could be used to generate the requirements of any software suppliers which could be involved.

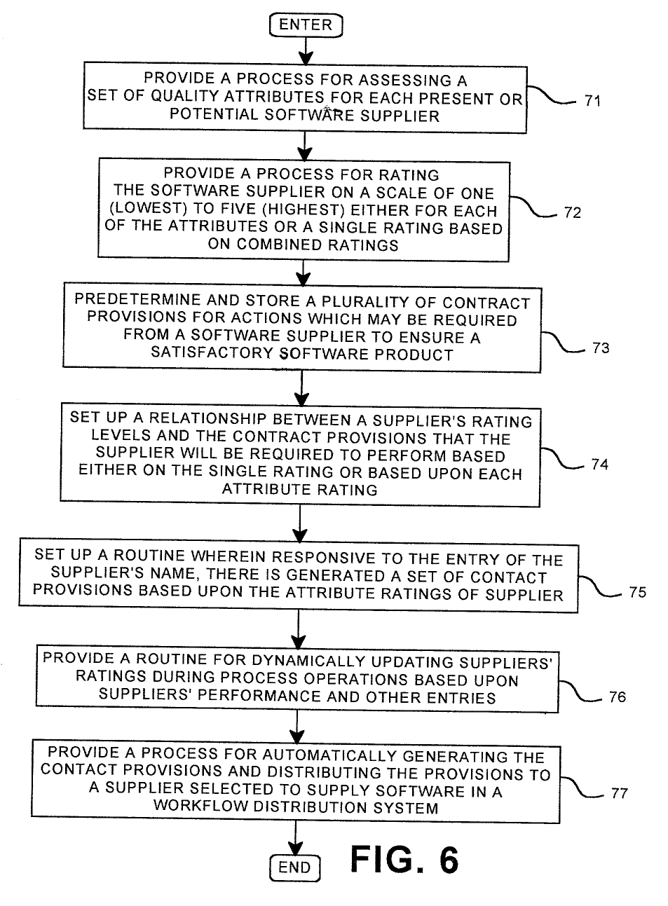

With reference to the flowchart of FIG. 6, there will be described an illustrative process of how the process of the present invention is set up. A process is provided for assessing a set of quality attributes for each present or potential software supplier, step 71. Then, there is set a process for rating any supplier on a scale of one to five for each of the set of attributes or as a single quality level based upon the combined attribute ratings, step 72. There are predetermined and stored a plurality of contract provisions for actions that may be required of software suppliers to ensure a satisfactory software product, step 73. A relationship between a supplier's rating levels and the contract provisions that the supplier will be required to perform, based upon either the single rating or based upon each attribute rating, is set up, step 74. There is set up a routine wherein responsive to the entry of the supplier's name, there is generated a set of contract provisions based upon the attribute ratings of the supplier, step 75. There is provided a routine for dynamically updating the suppliers' ratings during process operations based upon suppliers' performance and other entries, step 76. Finally, there is provided a process for automatically generating the contract provisions and distributing the provisions to a supplier selected to supply software in a work flow distribution system, step 77.

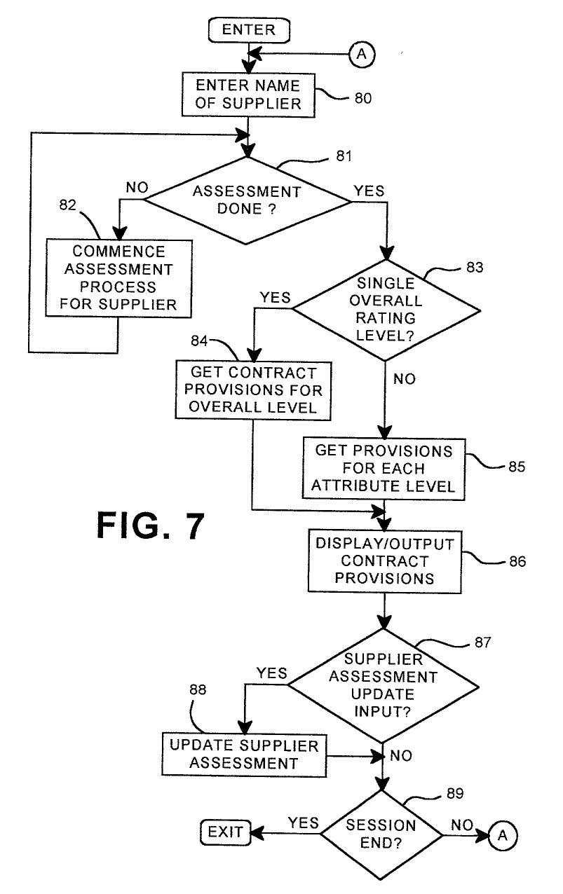

With respect to FIG. 7, there will now be described a running of the process set up in FIG. 6. To initiate the generation of contract terms, the user enters the name of the proposed supplier, step 80. A determination is made as to whether an assessment has already been completed for the supplier, step 81. If No, the supplier is set up for an assessment by any of the techniques described above, step 82, and the process is returned to step 81 where the completion of an assessment is awaited to be determined. If the determination in step 81 is Yes, then a further determination is made, step 83, as to whether the supplier is assessed with a single overall combined rating level. If Yes, the predetermined contract requirements for that level are retrieved from storage, step 84. If No, then the predetermined contract requirements for each attribute level are retrieved from storage, step 85. In either case, the contract requirements are output and displayed, step 86. At this point, a determination is made as to whether there has been an assessment update for the supplier being contracted with, step 87. If Yes, the supplier assessment is updated, step 88. Then, or if the decision in step 87 is No, a determination may conveniently be made as to whether the session is at an end, step 89. If Yes, the session is ended. If No, the process is returned to initial step 80 via branch “All”.

A convenient implementation of the present invention is in an application program 40 made up of programming steps or instructions resident in RAM 14, FIG. 1, of the process management server computers during various operations. Until required by the computer system, the program instructions may be stored in another readable medium, e.g. in disk drive 20, or in a removable memory such as an optical disk for use in a CD ROM computer input, or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Internet, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. A computer controlled display system for generating quality assurance contract requirements for software suppliers comprising:
means for assessing the quality level of each of a set of quality attributes of said software suppliers; and
means for generating for each of said quality attributes at least one contract requirement for said supplier based upon the quality level of said attribute.

2. The computer controlled display system of claim 1 wherein:
said means for assessing the quality level includes means for determining one of a plurality of quality levels for each of said set of quality attributes, and
said means for generating includes means for generating a different contract requirement for each of said quality levels for each attribute.

3. The computer controlled display system of claim 2 wherein no contract requirement is generated for at least one of said quality levels for at least one of said quality attributes.

4. The computer controlled display system of claim 2 wherein said means for determining said quality levels determines said levels dynamically during the system operation.

5. The computer controlled display system of claim 2 wherein:
said set of quality attributes consists of a single overall quality characteristic having several predetermined quality levels, and
said means for generating provides a plurality of contract requirements for each of said predetermined quality levels.

6. The computer controlled display system of claim 1 wherein said contract requirement involves tracking and reporting of said software development.

7. The computer controlled display system of claim 1 wherein said contract requirement involves tracking and reporting of testing of said software.

8. The computer controlled display system of claim 1 wherein said contract requirement involves software supplier risk identification and reduction.

9. The computer controlled display system of claim 1 wherein said contract requirement involves the management processes of said supplier.

10. The computer controlled display system of claim 1 wherein:
s aid display system assigns said software supply function to said software supplier in an overall work flow distribution system; and
said means for generating automatically generate and distribute said contract requirements to said supplier in response to the selection of said supplier.

11. A method for generating, on a user interactive computer controlled display system, quality assurance contract requirements for software suppliers comprising:
assessing the quality level of each of a set of quality attributes of said software supplier; and
generating for each of said quality attributes at least one contract requirement for said supplier based upon the quality level of said attribute.

12. The method of claim 11 wherein:
said step of assessing the quality level includes determining one of a plurality of quality levels for each of said set of quality attributes, and
generating a different contract requirement for each of said quality levels for each attribute.

13. The method of claim 12 wherein no contract requirement is generated for at least one of said quality levels for at least one of said quality attributes.

14. The method of claim 12 wherein said step of assessing said quality levels determines said levels dynamically during the system operation.

15. The method of claim 12 wherein:
said set of quality attributes consists of a single overall quality characteristic having several predetermined quality levels, and
a plurality of contract requirements for each of said predetermined quality levels is generated.

16. The method of claim 11 wherein said contract requirement involves tracking and reporting of said software development.

17. The method of claim 11 wherein said contract requirement involves tracking and reporting of testing of said software.

18. The method of claim 11 wherein said contract requirement involves software supplier risk identification and reduction.

19. The method of claim 11 wherein said contract requirement involves the management processes of said supplier.

20. The method of claim 11 wherein:
said software supply function is assigned to said software supplier in an overall work flow distribution method; and
said contract requirements are automatically generated and distributed to said supplier in response to the selection of said supplier.

21. A computer program having program code included on a computer readable medium operable in a computer controlled display system for generating quality assurance contract requirements for software suppliers comprising:
means for assessing the quality level of each of a set of quality attributes of said software supplier; and
means for generating for each of said quality attributes at least one contract requirement for said supplier based upon the quality level of said attribute.

22. The computer program of claim 21 wherein:
said means for assessing the quality level includes means for determining one of a plurality of quality levels for each of said set of quality attributes, and
said means for generating includes means for generating a different contract requirement for each of said assessed quality levels for each attribute.

23. The computer program of claim 22 wherein no contract requirement is generated for at least one of said quality levels for at least one of said quality attributes.

24. The computer program of claim 22 wherein said means for assessing said quality levels determines said levels dynamically during the system operation.

25. The computer program of claim 22 wherein:
said set of quality attributes consists of a single overall quality characteristic having several predetermined quality levels, and
said means for generating provides a plurality of contract requirements for each of said predetermined quality levels.

26. The computer program of claim 21 wherein said contract requirement involves tracking and reporting of said software development.

27. The computer program of claim 21 wherein said contract requirement involves tracking and reporting of testing of said software.

28. The computer program of claim 21 wherein said contract requirement involves software supplier risk identification and reduction.

29. The computer program of claim 21 wherein said contract requirement involves the management processes of said supplier.

30. The computer program of claim 21 wherein:
said display system assigns said software supply function to said software supplier in an overall work flow distribution system; and
said means for generating automatically generate and distribute said contract requirements to said supplier in response to the selection of said supplier.
